(19) United States
(12) Patent Application Publication
(10) Pub. No.: US 2025/0089930 A1
(43) Pub. Date: Mar. 20, 2025

(54) BEVERAGE STATION

(71) Applicant: Starbucks Corporation, Seattle, WA (US)

(72) Inventors: Michael R. Cummer, Seattle, WA (US); Pradnyesh U. Rokde, Bellevue, WA (US); Stephanie W. Lim, Seattle, WA (US); Izaak Matthew Koller, Seattle, WA (US); Paloma Deborah Carrington-Bataller, Seattle, WA (US)

(21) Appl. No.: 18/888,765

(22) Filed: Sep. 18, 2024

Related U.S. Application Data
(60) Provisional application No. 63/583,796, filed on Sep. 19, 2023.

(51) Int. Cl. A47J 31/52; A47J 31/30; A47J 31/41; A47J 31/44

(52) U.S. Cl. CPC A47J 31/52; A47J 31/303; A47J 31/41; A47J 31/4489

(57) ABSTRACT

Disclosed herein are methods of beverage preparation and beverage preparation devices and systems. Example devices and systems described herein can include a first beverage preparation utility configured to automatically perform at least one beverage preparation routine; and a second beverage preparation utility configured to automatically perform at least one beverage preparation routine. The devices and systems can include at least one controller communicatively coupled to at least one of the first beverage preparation utility or the second beverage preparation utility. The at least one controller is configured to cause the first beverage preparation utility to perform at least one beverage preparation routine based at least in part on the at least one beverage preparation routine performed by the second beverage preparation utility.

### INCORPORATION BY REFERENCE TO ANY PRIORITY APPLICATIONS

This application claims priority to U.S. Provisional Patent Application No. 63/583,796, filed Sep. 19, 2023, the entirety of which is incorporated herein by reference.

### FIELD

The present disclosure relates to systems and methods for preparing beverages, such as, systems and methods for preparing cold beverages in a beverage station.

### BACKGROUND

Beverages at a coffee store can include a large number of ingredients that can be combined in various ways and at various doses for various drinks. Conventionally, in response to receiving a beverage order, a barista creates the beverage by manually retrieving ingredients from their respective containers and bringing the ingredients to respective equipment to create a drink. Drink orders can be increasingly more complicated, in particular with increasing customization. The locations of the ingredients and equipment needed for one drink may be located at various locations that require the barista to travel. Storing the ingredients and equipment in a way that is practical and accessible for use and for refilling can also be challenging, especially at large scales.

### BRIEF DESCRIPTION OF THE DRAWINGS

FIG. 1 illustrates an embodiment of a beverage station.

FIG. 2 schematically illustrates an embodiment of a beverage station.

FIG. 3 schematically illustrates another embodiment of a beverage station

FIG. 4 illustrates an example of an order status indication displays.

FIG. 5 is a flow chart of a method of using the beverage station shown in FIG. 1.

FIG. 6 illustrates steps of an example method for receiving and monitoring orders in a beverage station.

FIG. 7 illustrates a block diagram illustrating an embodiment of a computer hardware system configured to run software for implementing one or more embodiments of the system, methods, and devices disclosed herein.

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

### DETAILED DESCRIPTION

Various extraction systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein.

Conventionally, in response to receiving a beverage order, a barista creates the beverage by retrieving or dispensing ingredients. The beverage order can also require different pieces of equipment, which can also be located at various places. Furthermore, customers often request modifications or customizations to the standard recipe. This can require a barista travelling to another area for this additional ingredient. Customization can place an additional burden on baristas, particularly as the operational approach and systems may be designed around specific, pre-determined beverage build recipes. Additionally, ingredient modifications often complicate beverage orders and further exacerbate the burden on baristas. For example, a customer ordering a customized beverage may ultimately receive a beverage with errors or there can be delays in preparing the beverage, which can negatively affect the customer's experience.

An aspect of the present disclosure, is the recognition that creating beverages can be time consuming and complex. Beverages can get increasingly complex and burdensome as recipes change, new recipes are added, and more customizations are possible. The process of building beverages can be labor intensive and can require a lot of space. Creating a beverage can include collecting and retrieving a variety of ingredients in various locations by hand. Additionally, creating a beverage can require moving a container to various stations to use different equipment. Various steps can take time and space, such as blending various ingredients. Not only can these inefficiencies be time consuming, they can also cost more, especially in terms of labor costs.

In some examples, a first beverage and a second beverage can be prepared using a same beverage preparation utility. In such examples, a portion of the first beverage may sit for a time while a portion of the second beverage is being prepared using the beverage preparation utility. This sitting for a time can cause inefficiencies, quality degradation, and/or waste. In some instances, inefficiencies may also occur as a beverage preparation utility is prepared for use itself. In some examples, water may need to be dispensed into a pitcher between uses of the pitcher for use in beverage preparation. In such examples, it may take time to fill up the pitcher for each use. An aspect of the present disclosure is the recognition that the anticipation of beverage preparation steps and needs and coordination between beverage preparation utilities can be used to increase throughput during preparation of a single beverage or a plurality of beverages. As such, a central control system that can control one or more beverage preparation utilities can be beneficial for beverage preparation.

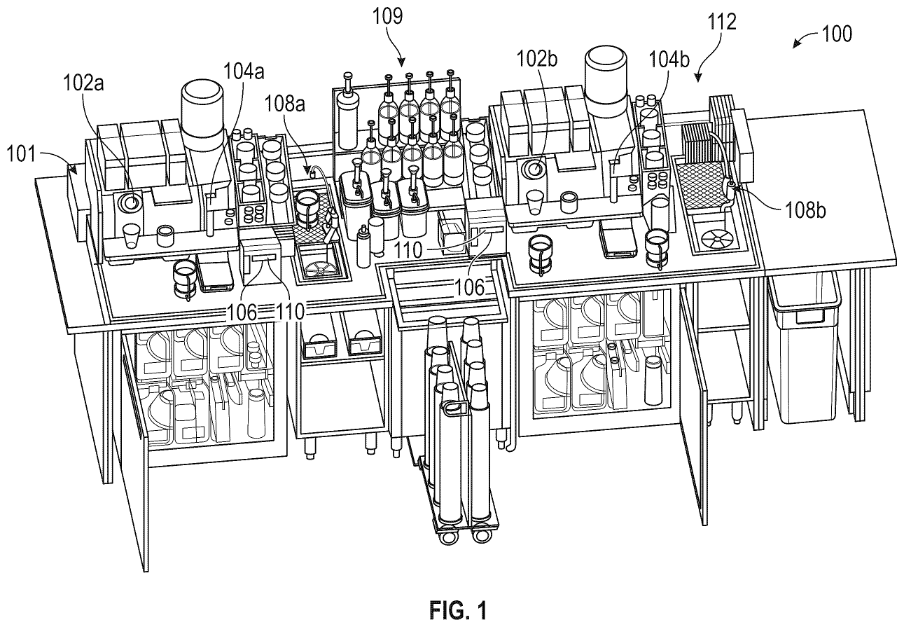

To address these or other concerns, disclosed herein is an embodiment of a beverage preparation station for preparing beverages. FIG. 1 illustrates an example of a beverage preparation station 100. The beverage preparation station 100 can include a first set of beverage preparation utilities (e.g., devices, systems) 101 which, as will be explained below can be arranged in various configurations. In the illustrated embodiment, the first set of beverage preparation utilities 101 includes a first beverage preparation utility (e.g., device, system) 102a, a second beverage preparation utility 104a (e.g., device, system). The beverage preparation station 100 can include a controller 106 communicatively coupled to the first beverage preparation utility 102a and the second beverage preparation utility 104a of the first set of beverage preparation utilities 101. As shown in FIG. 1, the first set of beverage preparation utilities 101 can also include a third beverage preparation utility (e.g., device, system) 108a and a display 110 communicatively coupled to the controller 106. FIG. 1 also shows a second set of beverage preparation utilities 112 positioned near or adjacent the first set 101 of utilities.

The first beverage preparation utility 102a, the second beverage preparation utility 104A, and/or the third beverage preparation utility 108a can include any apparatus (e.g., device, system) configured to prepare a beverage or a component (e.g., portion) of a beverage. In some embodiments, the first beverage preparation utility 102a, the second beverage preparation utility 104A, and/or the third beverage preparation utility 108a can include a portion of a beverage preparation machine. In some embodiments, the first beverage preparation utility 102a, the second beverage preparation utility 104A, and/or the third beverage preparation utility 108a can include separate apparatuses (e.g., devices, systems). In the example shown in FIG. 1, the first beverage preparation utility 102a includes an espresso system of an espresso machine, the second beverage preparation utility 104a includes a milk system of the espresso machine, and the third beverage preparation utility 108a includes a water system. The espresso system of the espresso machine can be configured to prepare and dispense espresso shots for beverages. The milk system of the espresso machine can be configured to heat, steam (e.g., froth), and/or dispense milk for beverages. The water system can be configured to dispense water for beverages and/or automatically refills a water container.

As described further herein, the controller 106 may be configured to cause the first beverage preparation utility 102a, the second beverage preparation utility 104a, and/or the third beverage preparation utility 108a to perform at least one beverage preparation routine for preparing a beverage or a component of a beverage. For example, the controller 106 may be configured to cause the first beverage preparation utility 102a to perform a first beverage preparation routine so the first beverage preparation utility 102a prepares and dispenses an espresso shot, the second beverage preparation utility 104a to perform a second beverage preparation routine so the second beverage preparation utility 104a prepares steam (e.g., frothed) milk, and/or the third beverage preparation utility 108a to perform a third beverage preparation routine so the third beverage preparation utility 108a refills a water container. The controller 106 may be configured to coordinate the timing of the first beverage preparation routine, the second beverage preparation routine, and/or the third beverage preparation routine in order to reduce or minimize the time required to prepare a beverage with the first beverage preparation utility 102a, the second beverage preparation utility 104a, and/or the third beverage preparation utility 108a in order to increase throughput of the beverage preparation station 100. The controller 106 may be configured to coordinate the timing of the first beverage preparation routine, the second beverage preparation routine, and/or the third beverage preparation routine in order to reduce or minimize the time prepared components of the beverage sit at the beverage preparation station 100 before the prepared components are combined to prepare the beverage. The controller 106 may be configured to coordinate the timing of the first beverage preparation routine, the second beverage preparation routine, and/or the third beverage preparation routine so the first beverage preparation utility 102a, the second beverage preparation utility 104a, and/or the third beverage preparation utility 108a perform the first beverage preparation routine, the second beverage preparation routine, and/or the third beverage preparation routine simultaneously. The controller 106 may be configured to coordinate the timing of the first beverage preparation routine, the second beverage preparation routine, and/or the third beverage preparation routine so at least a portion of the first beverage preparation routine, the second beverage preparation routine, and/or the third beverage preparation routine are performed simultaneously.

In the example shown in FIG. 1, the second set of beverage preparation utilities 112 can include substantially similar beverage preparation utilities as the first set 101 of beverage preparation utilities, although in other examples, various beverage preparation stations can include various beverage preparation utilities that are at least in part different from each other. Accordingly, in the illustrated embodiment, the second set of beverage preparation utilities 112 includes a first beverage preparation utility 102b, a second beverage preparation utility 104b, and a third beverage preparation utility 108b. In the example shown in FIG. 1 the first beverage preparation utility 102a, 102b is an espresso system (as described in more detail below) that can produce one or more espresso shots at a time, and the second beverage preparation utility 104a, 104b is a milk preparation system that can produce hot or warm milk and in certain embodiments hot or warm frothed milk (e.g., steamed milk), and the third beverage preparation utility 108a, 108b is a water system. But, in other examples, the first and second sets of beverage preparation utilities 101, 112 can include any number of beverage preparation utilities. Examples of additional beverage preparation station utilities will be described in more detail below. The controller 106 can be communicatively coupled to the first beverage preparation utility 102b, the second beverage preparation utility 104b, the third beverage preparation utility 108b, and/or a display 110 of the second set of utilities 112.

The beverage preparation station 100 can utilize any number of beverage preparation utilities and/or sets of beverage preparation utilities for preparation of a beverage or a plurality of beverages. As will be explained in more detail below, the beverage preparation utilities provide users preparing beverages with tools to increase ease and efficiency when building a beverage. Some of the beverage preparation utilities can be automated and in certain embodiments the operation of the beverage preparation utilities can be coordinated so as to improve throughput through the station 100. For example, the first beverage preparation utility 102a, 102b (e.g., an espresso machine) can be configured to prepare an espresso shot upon an indication that a user would like to dispense an espresso shot to build a beverage (e.g., user presses a button). In some examples, the first beverage preparation utility 102a, 102b can alternatively or additionally be automated by receiving an indication for preparation of an espresso shot by from the controller 106 (e.g., due to a timer, temperature measurement, or other indication to the controller 106 that an espresso shot is to be dispensed). Although the example described above includes preparation of an espresso shot, a plurality of beverage preparation utilities can be automated by direct user input or by indications from the controller 106.

As noted above, in the example shown in FIG. 1 the first beverage preparation utility 102a, 102b is an espresso system which can be an automatic hot espresso system provided to prepare and dispense espresso shots for beverages. In some examples, the automatic espresso system can be a hot espresso system or a cold espresso system. In some examples, the hot espresso system can be configured to hold a plurality of bean types (e.g., 2 or 3 bean types), and receive remote commands (e.g., commands from the controller 106) for output functions such as bean type and shot quantity. In some examples, the espresso system can detect the presence of a shot glass under a dispense point. The espresso system may also be configured to execute a plurality of automated functions such as automatic pulling and dispensing of espresso shots. In some examples, a user can pause or interrupt an automated function for a desired purpose. Additionally, the automatic espresso system can communicate messages to a user (e.g., through the display 110). For example, the espresso can provide an indication regarding a type of beverage in a shot glass and/or whether espresso shots have been sitting in a shot glass for a longer than desired time period. In some examples, the espresso system can detect if a shot is dispensed that is not of desired quality (e.g., undesired density) and notify a user as such. In some examples, the espresso machine can inform a user what product (e.g., espresso shot) was dispensed into a container such as a cup or a shot glass.

As noted above, in the example shown in FIG. 1 the second beverage preparation utility 104a, 104b is a milk system. The second beverage preparation utility 104 can be an automated hot milk system provided to heat and dispense milk for beverages. In some examples, the milk system can be a hot milk system configured for preparation of hot beverages and/or a cold milk system configured for preparation of cold beverages. The milk system can include components to receive remote commands (e.g., commands from the controller 106) for output functions such as milk type, foam type, and foam temperature. The milk system can also send signals to the controller 106. For example, the milk system can include a thermometer to determine milk temperature. The milk system can send milk temperature information to the controller 106 to indicate when milk is ready to be added to a beverage.

In some examples, the milk system can be configured to provide steamed (e.g., frothed) milk for any suitable beverage size in 20-30 seconds total time elapsed. In some examples, the milk system includes components such as heating elements to steam a plurality of milk types. In some examples, the steamed milk system can hold a plurality of milk types such as 2% milk and whole milk and steam the plurality of milk types as needed without replacing milk types. Milk types can also include, coconut milk, almond milk, oat milk, or any other milk suitable for building a beverage. Additionally, the milk system can communicate messages to a user (e.g., through the display 110) such as a message that a beverage container is full and/or whether milk has been sitting in a container for a longer than desired time period.

As noted above, in the example shown in FIG. 1, the third beverage preparation utility 108a, 108b can be a water system. The water system can be an ambient water system provided to dispense water for beverages. In some examples, the water system can include one or more of a hot water system, a cold/ambient water system and/or an ice system. The water systems can provide a continuous refill mechanism to cause a container to remain in an always-full state such that the water system automatically refills a water container in between uses. For example, a water system may include a water faucet, a scale, and a pitcher. In some examples, the water faucet may automatically be activated when a weight within a predetermined weight range is detected by the scale. For example, the weight range can be a weight of at least a predetermined weight of an empty pitcher (with or without a lid) but less than a weight of a water-filled pitcher. Once the weight reaches the weight of a water-filled pitcher, the water faucet stops. Additionally, if the scale detects a weight less than an empty pitcher, such as when the pitcher has been removed from the scale, the controller 106 can signal the faucet to be in an off state. As such, the water system can automatically keep a pitcher full between uses.

Although in the example above, the water system uses weight to measure the water, other sensors can also be used. For example, a light sensor can be used to determine if water rises above a predetermined fluid fill line or falls below a predetermined low fluid line. In other examples, the water system can use other sensors/methods for determining a fluid amount in a pitcher that are suitable to automatically fill and stop filling a pitcher. The continuous refill system can also be configured to refill a plurality of beverage components such as ice, water, and syrup.

In some examples, the water system can maintain a water temperature at a desired temperature for a desired period of time. For example, a hot water system can maintain water at a temperature of about 200° F. +/−5° F. In other examples, an ambient water system can maintain water at about 70° F. +/−5° F., and an ice water system can maintain water at about 32° F. or colder. The water system can maintain water temperature at a desired temperature for a set period of time, (e.g., 10 min., 20 min., 30 min., 40 min., 50 min., 60 min., etc.). In some examples, the water system can indicate to a user when temperature is at a specified temperature (e.g., below a set temperature). The water system can also communicate that water has sat beyond a threshold time, in which case the water may need to be disposed of or repurposed.

In some examples, the water system can be connected to an ice making system. In examples including the ice making system, the water system can include a means to make and store ice in high density. The water system may be arranged such that minimal air gaps or excess space exist when the ice is dispensed into the container. The water system may produce ice at a rate from about .0751b/min to about 31b/min. For example, the ice making system may produce ice at a rate of 11b/min.

Although the first and second sets 101, 112 of utilities have a first beverage preparation utility 102a, 102b, a second beverage preparation utility 104a, 104b, and a third beverage preparation utility 108a, 108b, in some examples, the beverage preparation station can have any number of beverage preparation utilities suitable for preparing a beverage or a plurality of beverages. For example, as shown in FIG. 1, the beverage preparation station 100 can include a fourth beverage preparation utility (e.g., device, system) 109. The controller 106 may be configured to cause the fourth beverage preparation utility 109 to perform a fourth beverage preparation routine. For example, the fourth beverage preparation utility 109 can include a beverage modifier dispensing system with one or more beverage modifier dispensers. The beverage modifier dispensing system can be configured to automatically dispense one or more beverage modifiers (e.g., sauce, syrup or flavor). The controller 106 can initiate timing of the fourth beverage preparation routine based on the timing of the first beverage preparation routine, the second beverage routine, and/or the third beverage preparation routine. As will be explained below, the beverage preparation utilities can all be configured to operate concurrently with each other

Moreover, although in the illustrated embodiment, the first beverage preparation utility 102a, 102b is an espresso machine, the second beverage preparation utility 104a, 104b is a milk preparation system, and the third beverage preparation utility 108a, 108b is a water system, in other examples, the first beverage preparation utility 102a, 102b, the second beverage preparation utility 104a, 104b, and the third beverage preparation utility 108a, 108b, can be any suitable utility for preparing a beverage. For example, a beverage preparation utility can be a hot espresso system, a cold espresso system, a hot milk system, a cold milk system, a hot water system, an ambient water system, an ice system, a powder system, or any other system for preparing beverages.

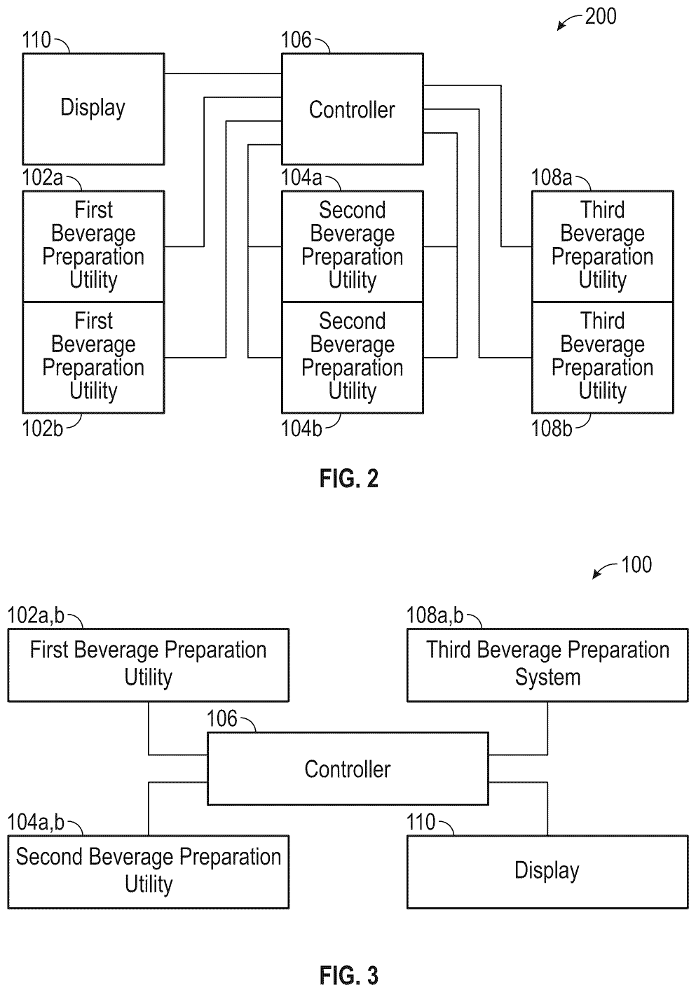

FIG. 2 shows an alternative configuration of the beverage station 200. In some examples, the beverage station 200 can be disposed in the alternative configuration such that substantially similar beverage preparation utilities can be directly adjacent each other. In such examples, similar beverage ingredients can be prepared and coordinated next to each other. For example, a first espresso shot, can be prepared next to a second espresso shot and coordinated such that the first espresso shot and the second espresso shot can be accessed substantially simultaneously to build a beverage having two espresso shots. In other examples, a first espresso shot and a second espresso shot can be prepared and coordinated such that the first espresso shot and the second espresso shot can be accessed substantially at staggered times to build two separate beverages simultaneously.

In the example shown in FIG. 2, the beverage station includes two first beverage preparation utilities 102a, 102b directly adjacent each other, two second beverage preparation utilities 104a, 104b directly adjacent each other, and two third beverage preparation utilities directly adjacent each other. The example shown in FIG. 2 shows an example of the first beverage preparation utility 102a, 102b that includes a first espresso machine and a second espresso machine, the second beverage preparation utility 104a, 104b includes a first milk system and a second milk system, and the third beverage preparation utility 108a, 108b includes a respective always full milk system and an always full water system.

In some examples, one or more of the beverage preparation utilities include components to receive remote commands from the controller 106 (e.g., processor, wireless signal receiver, etc.). For example, the espresso system (hot/cold systems) can be configured to receive remote commands to automatically perform various functions.

The controller 106 can be an electronic central controller that includes a processor and computer executable instructions to coordinate beverage preparation functions such as functions of the first beverage preparation utility 102a, 102b and the second beverage preparation utility 104a, 104b. The controller 106 can be used to optimize throughput of beverage preparation by indicating optimal times for initiation of beverage preparation utility functions and thereby providing minimal waiting periods between functions. The controller 106 can also be communicatively coupled to the display 110 (described in further detail below), which provides information such as drink status indications to a user. In some examples, as shown in FIG. 1, the first set of beverage preparation utilities 101 can include a first controller 106 configured to control the utilities 102a, 104a, 108a of the first set of beverage preparation utilities 101, and the second set of beverage preparation utilities 112 can include a second controller 106 configured to control the utilities 102b, 104b, 108b of the second set of beverage preparation utilities 112. In some examples, as shown in FIGS. 2 and 3, the beverage preparation stations 100, 200 can include a controller (e.g., a central controller) 106 configured to control the utilities 102a, 104a, 108a of the first set of beverage preparation utilities 101, and the utilities 102b, 104b, 108b of the second set of beverage preparation utilities 112.

As shown in FIG. 3, the controller 106 is communicatively coupled to the first beverage preparation utility 102a, 102b, the second beverage preparation utility 104a, 104b, and/or the third beverage preparation utility 108a, 108b. The controller 106 is configured to send electrical signals to the first beverage preparation utility 102a, 102b, the second beverage preparation utility 104a, 104b, and/or the third beverage preparation utility 108a, 108b such that the first beverage preparation utility 102a, 102b and the second beverage preparation utility 104a, 104b, and/or the third beverage preparation utility 108a, 108b can be activated/initiated or deactivated by the controller 106. The controller 106 is also configured to receive signals from the first beverage preparation utility 102a, 102b and the second beverage preparation utility 104a, 104b, and/or the third beverage preparation utility 108a, 108b such that the controller 106 can receive a status of the first beverage preparation utility 102a, 102b and the second beverage preparation utility 104a, 104b, and/or the third beverage preparation utility 108a, 108b.

The controller 106 can be configured to cause the first beverage preparation utility 102a, 102b to perform the at least one beverage preparation routine for a first beverage and cause the second beverage preparation utility 104a, 102b to perform the at least one beverage preparation routine for a second beverage. For example, the controller 106 can cause the first beverage preparation utility 102a, 102b to dispense a predetermined amount of espresso and cause the second beverage preparation utility 104a, 104b to froth milk at a predetermined temperature. The controller 106 is configured such that the controller 106 can cause the first beverage preparation utility 102a, 102b to activate upon a determination that the second beverage preparation utility 104a, 104b has reached a certain point in preparation. For example, the first beverage preparation utility 102a, 102b can dispense a predetermined amount of espresso upon a determination that the second beverage preparation utility 104a, 104b has caused milk to reach a certain temperature (e.g., 200° F.). Although the controller 106 can cause the first beverage preparation utility 102a, 102b to activate upon a determination that the second beverage preparation utility 104a, 104b has reached a certain point in preparation, in some examples, the controller 106 can cause the second beverage preparation utility 104a, 104b to activate upon a determination that the first beverage preparation utility 102a, 102b has reached a certain point in preparation, or upon determination that another suitable point in the preparation of at least one beverage is reached.

The controller 106 can be configured to receive signals from a plurality of sensors and control mechanisms disposed about the beverage preparation station 100. For example, the system for preparing beverages may include at least one thermometer to determine the temperature of drinks, scales to determine held fluid weight of a fluid container such as a pitcher, a timer to monitor the time required to heat a drink, or any other control mechanism that can provide signals to indicate information regarding a status of a process to make a drink. In some examples, the controller 106 can receive signals from a proximity sensor. For example, the controller can receive signals from a proximity sensor to determine if a vessel holding a drink has been moved. The controller 106 can also be configured to receive signals from a thermometer, a scale, a timer, or any other control mechanism that can provide signals to indicate information regarding a status of a process to make a drink. In some examples, the controller 106 can be configured to send signals to the beverage preparation utilities 104 to prepare a drink based on signals received from the sensors or other control mechanisms. For example, the controller 106 can initiate a beverage preparation routine when one or more containers for the espresso and/or milk are returned to the respective beverage preparation utilities 104. In some examples, the controller 106 can initiate a beverage preparation routine when an order indicator such as an order sticker is generated and/or taken by a user. In some examples, the controller 106 can initiate a beverage preparation routine when a first prior container for a previous beverage preparation routine is first removed. In some examples, the controller 106 can initiate a beverage preparation routine based on a time delay after first drink is prepared. In some examples, the controller 106 can initiate a beverage preparation routine based on a variable time delay based on a first drink completion time table. In some examples, the controller 106 can initiate a beverage preparation routine when any connected beverage preparation utility 104 is free to start a beverage preparation routine.

The controller 106 can further coordinate the preparation of drinks based on beverage preparation routines. In some examples, beverage preparation routines can include predetermined preparation timing such that a plurality of beverages is prepared at least partially concurrently. In some examples, the controller 106 includes data transmission components such as Wi-Fi, ethernet, Bluetooth, ZigBee, or any other suitable network connection to transmit data to a remote location. For example, the controller 106 can transmit data to a remote neural network, which can use the transmitted data to determine one or more likely beverage preparation routines based on at least one of the first beverage preparation routine or the second beverage preparation routine. The controller 106 can be further configured to receive information through the data transmission components from the neural network. The controller 106 can be further configured to alter the beverage preparation routines of beverage preparation utilities based on data received from a remote location such as the remote neural network.

In the example shown in FIG. 1, the display 110 is included to provide a means for a user to monitor a workstream and beverage preparation routines of the beverage preparation utilities. This display 110 allows users preparing a beverage to plan beverage preparation procedures for one beverage or a plurality of beverages based at least in part on information provided on the display 110. The display 110 can provide a clear user interface that easily communicates different drink components that are being prepared by different beverage preparation utilities 104. The display 110 supports higher speed operation that can become complicated when a plurality of ingredients (e.g., 4 different ingredients) may be dispensing at the same time. In some examples, the display can be any electronic display such as an LED, OLED, or any other display suitable to communicate information related to beverage preparation. For example, the display 110 can show a queue visualization screen that displays a drink queue for upcoming drink orders. In some examples, the display 110 is an interactive display such as a touch screen display. The display 110 is communicatively coupled to the controller 106 such that the controller 106 can provide display data to the display. In some examples, the display can be coupled to any number of beverage preparation utilities such as the first beverage preparation utility 102 and the second beverage preparation utility 104.

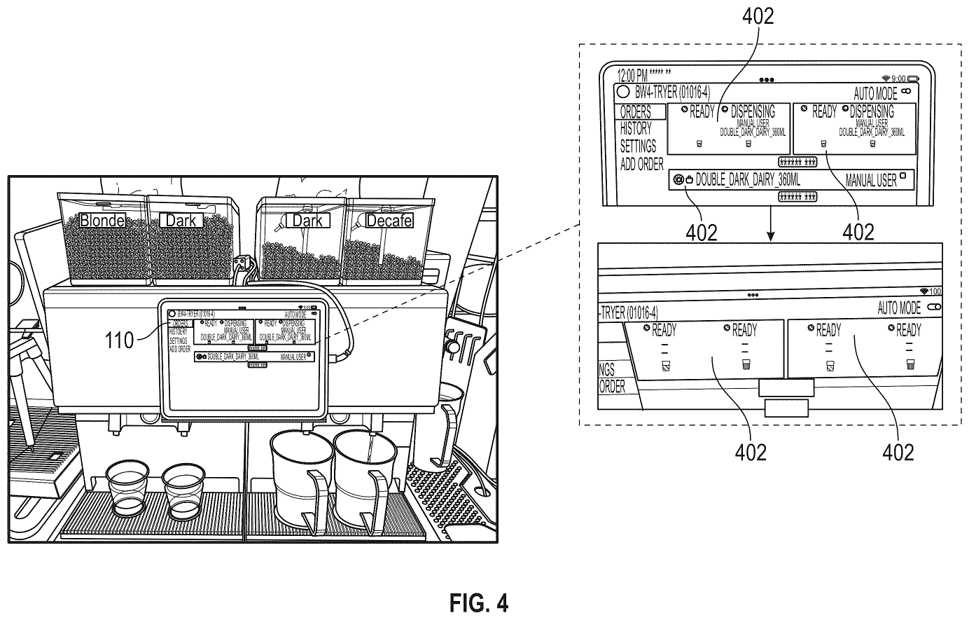

FIG. 4 shows an example of the display 110 showing a plurality of beverage preparation status indicators 402 for beverage preparation routines. In some examples, the display can include an onboard compute module display that shows outlet port status and activity for a plurality of drinks (e.g., two to four drinks) that are in process at beverage preparation utilities 104. This display 110 can also include interface controls for a user such as a barista to pause, reorder, and remake drinks or components. The interface controls can also be configured for a user to interact with a drink queue which can indicate drinks to be prepared. In some examples, a remote user such as a customer can send a signal to the controller 106 remotely to initiate beverage preparation prior to beverage pick-up (e.g., completing an online order). As such, in some examples, the controller 106 can include a wireless receiver and/or be communicatively coupled to a wireless network. The controller 106 can send instruction signals to the beverage preparation utilities 104 to initiate beverage preparation. The controller 106 can be configured to communicate with an order management system or point of sale system. The controller 106 can be configured to receive one or more beverage orders from the order management system or point of sale system. The controller 106 can be configured to generate the instructions signals based on the one or more beverage orders received from the order management system or point of sale system. The controller 106 can be located at the beverage preparation stations 100, 200 or at a remote location. The controller 106 can be communicatively coupled with the order management system or point of sale system via a wired connection (e.g., Ethernet cable) or a wireless connection (e.g., the Internet, Telex network, wireless radio network, Wi-Fi connection via a wireless network such as a local area network or a Bluetooth connection, etc.).

In some examples, the controller 106 can be configured to send instructions to the display 110 to provide beverage preparation status indicators for one or more beverage preparation utilities (e.g., first beverage preparation utility 102a, 102b, second beverage preparation utility 104a, 104b, third beverage preparation utility 108a, 108b). For example, the display 110 can show a beverage preparation status such as “in progress” and “complete” to indicate the status of a drink preparation. The display can also show a status of discrete portions of a beverage preparation routine to be accomplished by a particular beverage preparation utility. For example, if one step of a beverage preparation routine includes dispensing a shot of espresso, the display 110 can show “dispensing” while the shot of espresso is being prepared and dispensed. The display 110 can then show “ready” when the shot of espresso is being dispensed. The display 110 can further show a status of a second beverage preparation utility that is dispensing dairy. The display 110 can show “dispensing” while the dairy is being prepared and dispensed. The display can then show “ready” when the dairy is being dispensed. The display can similarly show status indicators for various functions displayed by various beverage preparation devices such as those described herein.

In some examples, the controller 106 can be communicatively coupled to an indicator device such as the display 110, an audio device such as a speaker, and/or a hand-held device of a user, to provide alert instructions. The alert instructions can cause the indicator device to send an alert to the user to indicate a window for user input to build a beverage. For example, the controller 106 can send a signal to one or more indicator devices when dairy is dispensed and an espresso shot is dispensed, such that a user can combine the dairy and the espresso shot in a serving container to build a drink.

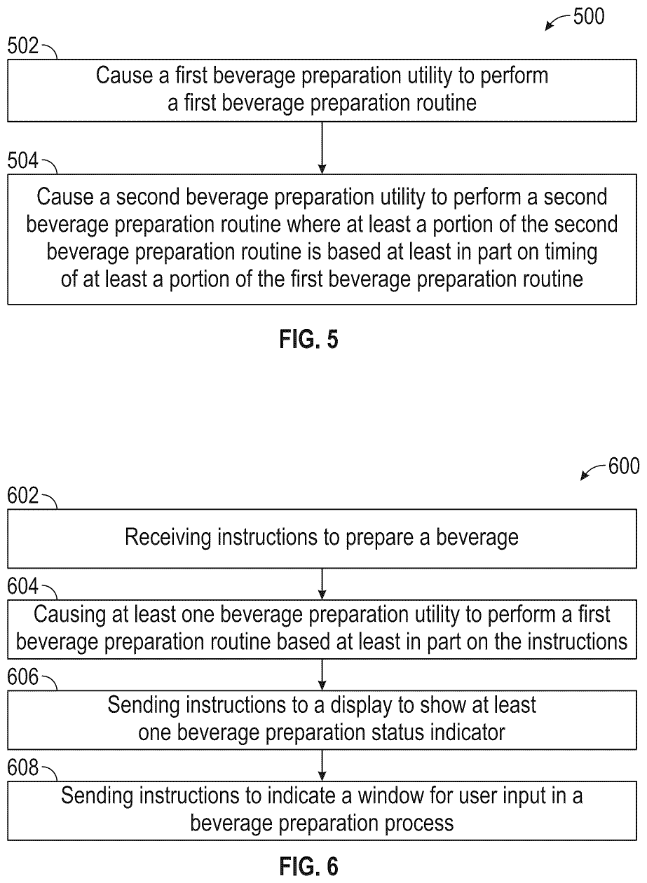

FIG. 5 shows an example process 500 for preparing a beverage using a beverage preparation station. At 502 the controller 106 causes the first beverage preparation utility 102a, 102b to perform a first beverage preparation routine. For example, the first beverage preparation routine can be preparing an espresso shot, frothing milk, heating water, preparing foam, or any other beverage preparation routine suitable to build a beverage. At 504, the controller 106 causes the second beverage preparation utility 104a, 104b to perform a second beverage preparation routine. For example, the second beverage preparation routine can be preparing an espresso shot, frothing milk, heating water, preparing foam, or any other beverage preparation routine suitable to build a beverage. The controller 106 initiates the second beverage preparation routine such that at least a portion of the second beverage preparation routine is based at least in part on timing of at least a portion of the first beverage preparation routine. As such the second beverage preparation routine can be initiated based at least in part on a time to completion of the first beverage preparation routine. For example, the first beverage preparation routine can be preparing an espresso shot, and the second beverage preparation routine can be frothing milk. If the first beverage preparation utility 102a, 102b takes 20 seconds to prepare the espresso shot, the controller 106 can determine when the second beverage preparation utility 104a, 104b has 20 seconds left to froth milk to a desired temperature. The controller 106 can then cause the first beverage preparation utility 102a, 102b to begin preparing the espresso shot simultaneously with the preparation of the frothing of the milk. At least a portion of the first beverage preparation routine and the second beverage preparation routine are performed at least in part concurrently such that the espresso shot is prepared at least in part simultaneously as the milk is frothed. As such, the espresso shot does not sit for an extended period of time without being used which increases freshness of the beverage and increases beverage preparation efficiency.

In some examples, the first beverage preparation routine pertains to a first beverage, and the second beverage preparation routine pertains to a second beverage. As such, the controller 106 can coordinate a first beverage preparation and a second beverage preparation at least in part simultaneously. For example, the controller 106 can determine that a first beverage and a second beverage require an espresso shot and frothed milk. The controller 106 can initiate timing of a first espresso shot when there are 10 seconds left before the milk is frothed. The controller 106 can then determine to wait until the milk has been frothed for the first drink, and the frothed milk for the second beverage is 10 seconds from being frothed to a desired level. The controller 106 can then initiate preparation of a second espresso shot for the second beverage. As such, the espresso shot does not sit for an extended period of time without being used which increases freshness of the beverage and increases beverage preparation efficiency for a plurality of beverages.

Although the beverage preparation routines are a first beverage preparation routine and a second beverage preparation routine, in some examples, the beverage preparation routines can be any number of beverage preparation routines suitable to build a beverage or any number of beverages. Although the beverage preparation routines are preparing an espresso shot and frothing milk, in some examples, the beverage preparation routines can be heating milk, pulling a beverage shot such as beverage flavoring or any other suitable action for building a beverage. In some examples, the beverage preparation routines can include routines related to the water system. For example, the beverage preparation routines can include routines such that the processor receives an indication that a fill level of a container has fallen below a target fill level and causes at least one beverage preparation utility (e.g., the water system) to fill the container until the target fill level is reached.

In some examples, data can be used to determine parameters of beverage preparation routines. For example, data can be entered into the controller 106 indicating a drink or a plurality of drinks to be prepared. In some examples, the instructions can come from a local input or a remote input. For example, the controller 106 can be operated remotely such that a user can initiate beverage preparation at a remote location from the beverage preparation station 100. For example, the controller 106 can activate an alert to notify a user who is at a remote location from the beverage preparation station 100 that an order, such as a mobile order, has been placed. The controller 106 can receive instructions from the user, from a remote controller to initiate ingredient preparation (e.g., pulling the espresso shots, steaming the milk, dispensing the hot water, etc.). As such, the beverage preparation station 100 can pre-prepare ingredients so that a user can efficiently begin beverage preparation with pre-prepared ingredients as soon as the user arrives at the beverage preparation station 100.

In some examples, one or more ingredients of the beverages prepared at 502 and/or 504 can include an ingredient that is a low volume ingredient (i.e., an ingredient not used in a high volume of beverages). For example, the ingredient may include an alternative milk (e.g., coconut milk, soy milk, etc.), a type of beverage shot (e.g., cold-pressed espresso, ristretto, long shot, etc.), or any other ingredient that is infrequently used to prepare a beverage. In these examples, at 502, a user may manually perform at least a portion of the first beverage preparation routine with the first beverage preparation utility 102a, 102b, and/or at 504, the user may manually perform at least a portion of the second beverage preparation routine with the second beverage preparation utility 104a, 104b. In some examples, the user may transmit instructions to the controller 106 to perform the process 500 if, for a particular order, none of the ingredients used in the first beverage preparation routine and/or the second beverage preparation routine are low volume ingredients. In some examples, the user may transmit instructions to the controller 106 to initiate ingredient preparation to perform the process 500 if, for a particular order, the ingredients used in the first beverage preparation routine and/or the second beverage preparation routine are not low volume ingredients.

FIG. 6 shows an example process 600 for preparing a beverage using a beverage preparation station. At 602 the controller 106 receives instructions to prepare a beverage. For example, the controller 106 can receive instructions from a user such as a barista or a customer as described above. The instructions can be received through direct user input to the display 110 from a local user or receive instructions from a remote user such as a customer ordering an online order from a mobile app. In some examples, the instructions are received based on input from a machine learning system (described in detail below). The instructions can include drink instructions including a type of drink and drink preparation options such as preferred ingredients.

In some examples, one or more ingredients of the beverage can include an ingredient that is a low volume ingredient (i.e., an ingredient not used in a high volume of beverages). For example, the ingredient may include an alternative milk (e.g., coconut milk, soy milk, etc.), a type of beverage shot (e.g., cold-pressed espresso, ristretto, long shot, etc.), or any other ingredient that is infrequently used to prepare a beverage. In these examples, the user may transmit instructions to the controller 106 at 602 if, for a particular order, none of the ingredients in the beverage are low volume ingredients. In some examples, the user may transmit instructions to the controller 106 at 602 to initiate ingredient preparation if, for a particular order, the ingredients in the beverage are not low volume ingredients. In some examples, if the beverage includes one or more low volume ingredients, the user may perform a beverage preparation routine to prepare the beverage using at least one beverage preparation utility (e.g., first beverage preparation utility 102a, 102b, second beverage preparation utility 104a, 104b, third beverage preparation utility 108a, 108b).

At 604, the controller 106 causes at least one beverage preparation utility 102, 104 to perform a beverage preparation routine based at least in part on the instructions to prepare a beverage. In some examples, the controller 106 sends instructions to one or more beverage preparation utilities (e.g., first beverage preparation utility 102a, 102b, second beverage preparation utility 104a, 104b, third beverage preparation utility 108a, 108b) to perform beverage preparation routines to fulfil the instructions with respect to drink type and drink preparation options. For example, the controller 106 can send instructions to the first beverage preparation utility 102a, 102b to begin preparing an instructed number of espresso shots. Alternatively or additionally, the controller 106 can send instructions to the second beverage preparation utility 104a, 104b to begin preparing a desired type and temperature of milk.

At 606, the controller 106 sends instructions to a display (e.g., display 110) to show a beverage preparation status indicator. In some examples, the beverage preparation status indicator can be provided to indicate the preparation status of one or more beverages previously prepared, being prepared, or in cue to be prepared at the beverage preparation station 100. In some examples, the beverage preparation status indicator can be updated when new orders are received from customers or other users. The beverage preparation status indicator can be further updated based on the status of one or more entire drinks or one or more components of a drink such as an espresso shot or dairy.

At 608, the controller 106 sends instructions to indicate a window for user input in a beverage preparation process. For example, the controller 106 can send instructions for user input when the ingredients are to be transferred from one container to another container or when two ingredients need to be mixed together. The indicator can be sent to a plurality of indication devices such as an audio device, a hand-held device, and/or the display 110. The indicator can be sent to one or any combination of indication devices that a user is most likely to be alerted to during the user input window. In some examples, the controller 106 can receive an indication of user input from direct user instruction or from sensors to confirm that a user has performed a beverage preparation activity. In some examples, the controller 106 can send follow-up indications if the controller 106 does not receive an indication of user input within a desired time.

Alternatively or additionally, machine learning data can be used to optimize the beverage preparation routines. In some examples, the controller 106 transmits data based on at least one of the first beverage preparation routine or the second beverage preparation routine to a machine learning system. For example, the controller 106 can transmit data related to timing to complete beverage preparation routines, a number of beverages prepared in a given time period, most common routines and ingredients used to build beverages, or other related information used to build beverages. In some examples, the controller 106 receives instructions from a machine learning system to optimize beverage preparation based at least in part on data sent from the beverage preparation station and/or other beverage preparation systems and/or beverage preparation utilities.

In some examples, the controller 106 adjusts at least one of the first beverage preparation routine or the second beverage preparation routine based on the instructions received from the machine learning system. For example, the controller 106 can cue an excess of espresso shots for simultaneously prepared drinks, based on an indication from the machine learning system that additional espresso shots are likely to be needed at a given time. In some examples, the machine learning system can anticipate re-ordered beverages and optimize beverage preparation efficiency based on the anticipated orders. In some examples, the machine learning system can determine an optimized sequence of hot and iced beverages to be made within a short time-period.

For example, if two hot beverages and two iced beverages are ordered in alternating sequence (e.g., hot-iced-hot-iced), the machine learning system can re-sequence the preparation of the orders in a non-alternating sequence (hot-hot-iced-iced). As such, the machine learning system can determine to sequence the beverage preparation such that hot beverages can be made concurrently or directly in sequence with each other.

Similarly, the machine learning system can determine to sequence beverage preparation such that iced beverages can be made concurrently or directly in sequence with each other. As such, the machine learning system can reduce the amount of time a user walks back and forth between hot and iced stations which can increase beverage preparation efficiency. In some examples, the machine learning system can determine a sequence to prepare drinks based on beverage preparation device availability. For example, a first drink may be customized such that the first drink utilizes a long machine time to complete a step (e.g., manually steaming/frothing a milk, which can take about 30 seconds). As such, the machine learning system can re-sequence the drink queue so that the next drink being prepared does not utilize the beverage preparation device(s) being used by the first drink. For example, the subsequent drink after a hot drink that requires manual milk steaming can be an iced drink that does not require milk steaming. In some examples, the machine learning system can determine that a particular ingredient is not available (e.g., a variety of milk ran out), and based on this determination, push any drinks that use the unavailable ingredient down in a preparation queue to prioritize drinks with available ingredients while the unavailable ingredients are resupplied.

In other examples, the controller 106 can adjust any number of beverage preparation routines based on any instructions from a machine learning system or other system which transmits data to the controller 106 to optimize beverage preparation. In the example described above the machine learning system is remote from the controller 106, but in other examples, the machine learning system can alternatively or additionally be included in the processor of the controller 106.

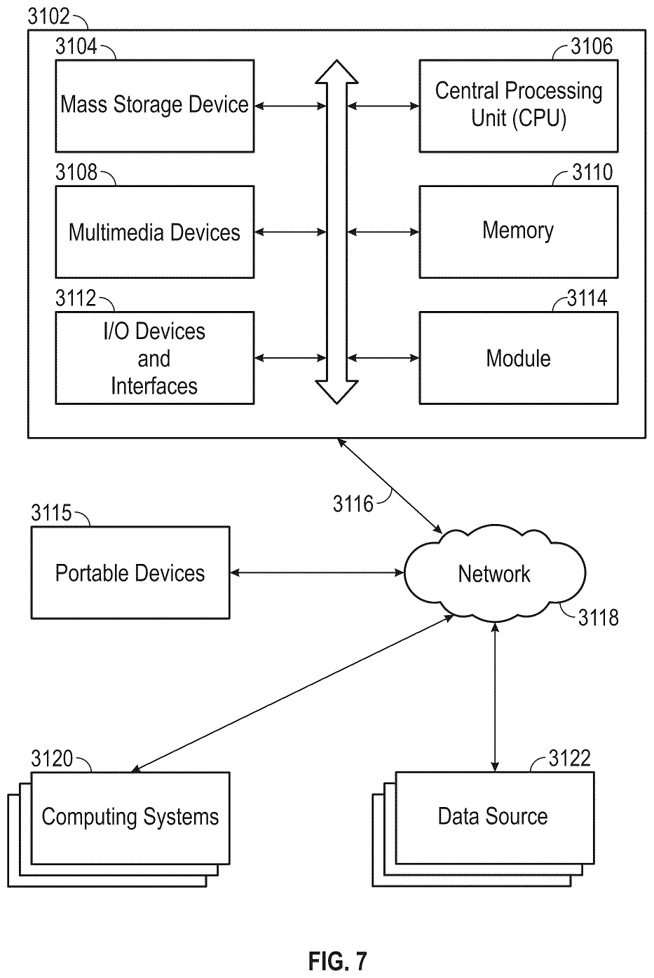

FIG. 7 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 7. The example computer system 3102 is in communication with one or more computing systems 3120 and/or one or more data sources 3122 via one or more networks 3118. While FIG. 7 illustrates an embodiment of a computing system 3102, it is recognized that the functionality provided for in the components and modules of computer system 3102 may be combined into fewer components and modules, or further separated into additional components and modules.

The computer system 3102 can comprise a module 3114 that carries out the functions, methods, acts, and/or processes described herein. The module 3114 is executed on the computer system 3102 by a central processing unit 3106 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 3102 includes one or more processing units (CPU) 3106, which may comprise a microprocessor. The computer system 3102 further includes a physical memory 3110, such as random-access memory (RAM) for temporary storage of information, a read only memory (ROM) for permanent storage of information, and a mass storage device 3104, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 3102 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 3102 includes one or more input/output (I/O) devices and interfaces 3112, such as a keyboard, mouse, touch pad, and printer. The I/O devices and interfaces 3112 can include one or more display devices, such as a monitor, that allows the visual presentation of data to a user. More particularly, a display device provides for the presentation of GUIs as application software data, and multi-media presentations, for example. The I/O devices and interfaces 3112 can also provide a communications interface to various external devices. The computer system 3102 may comprise one or more multi-media devices 3108, such as speakers, video cards, graphics accelerators, and microphones, for example.

The computer system 3102 may run on a variety of computing devices, such as a server, a Windows server, a Structure Query Language server, a Unix Server, a personal computer, a laptop computer, and so forth. In other embodiments, the computer system 3102 may run on a cluster computer system, a mainframe computer system and/or other computing system suitable for controlling and/or communicating with large databases, performing high volume transaction processing, and generating reports from large databases. The computing system 3102 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 3102 illustrated in FIG. 7 is coupled to a network 3118, such as a LAN, WAN, or the Internet via a communication link 3116 (wired, wireless, or a combination thereof). Network 3118 communicates with various computing devices and/or other electronic devices. Network 3118 is communicating with one or more computing systems 3120 and one or more data sources 3122. The module 3114 may access or may be accessed by computing systems 3120 and/or data sources 3122 through a web-enabled user access point. Connections may be a direct physical connection, a virtual connection, and other connection type. The web-enabled user access point may comprise a browser module that uses text, graphics, audio, video, and other media to present data and to allow interaction with data via the network 3118.

Access to the module 3114 of the computer system 3102 by computing systems 3120 and/or by data sources 3122 may be through a web-enabled user access point such as the computing systems' 3120 or data source's 3122 personal computer, cellular phone, smartphone, laptop, tablet computer, e-reader device, audio player, or another device capable of connecting to the network 3118. Such a device may have a browser module that is implemented as a module that uses text, graphics, audio, video, and other media to present data and to allow interaction with data via the network 3118.

The output module may be implemented as a combination of an all-points addressable display such as a cathode ray tube (CRT), a liquid crystal display (LCD), a plasma display, or other types and/or combinations of displays. The output module may be implemented to communicate with input devices 3112 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 3102 may comprise a physical or logical connection established between a remote microprocessor and a mainframe host computer for the express purpose of uploading, downloading, or viewing interactive data and databases on-line in real time. The remote microprocessor may be operated by an entity operating the computer system 3102, including the client server systems or the main server system, an/or may be operated by one or more of the data sources 3122 and/or one or more of the computing systems 3120. In some embodiments, terminal emulation software may be used on the microprocessor for participating in the micro-mainframe link.

In some embodiments, computing systems 3120 who are internal to an entity operating the computer system 3102 may access the module 3114 internally as an application or process run by the CPU 3106.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 3102 may include one or more internal and/or external data sources (for example, data sources 3122). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Caché), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 3102 may also access one or more databases 3122. The databases 3122 may be stored in a database or data repository. The computer system 3102 may access the one or more databases 3122 through a network 3118 or may directly access the database or data repository through I/O devices and interfaces 3112. The data repository storing the one or more databases 3122 may reside within the computer system 3102.

Although certain embodiments have been described herein in connection with flavors, sauces, or syrups for coffee or tea beverages, the systems described herein can be used for any type of ingredient or food product. For example, in some embodiments, the systems herein can be used to deliver fluid or solid ingredients, such as ketchup, mustard, barbecue sauce, cheese sauce, relish, onions, etc. In some embodiments, the systems herein can be used to produce other types of beverages such as sodas, juices, smoothies, milkshakes, etc.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently.

The various illustrative logical blocks, modular dispensers, routines, and algorithm steps described in connection with the embodiments disclosed herein can be implemented as electronic hardware, computer software, or combinations of both. To clearly illustrate this interchangeability of hardware and software, various illustrative components, blocks, modular dispensers, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks, devices, and systems in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, although different numbers have been used for similar components or features in different figures (e.g., different numbers have been used for the dispenser modules, displays, controllers, etc.), the structural and functional features described in connection with one figure, embodiment, or numbered element may be incorporated into the different-numbered components or features, and vice-versa. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A beverage station comprising:
a plurality of beverage preparation utilities comprising:
a first beverage preparation utility configured to automatically perform at least one beverage preparation routine; and
a second beverage preparation utility configured to automatically perform
at least one beverage preparation routine; and
a controller configured to cause the first beverage preparation utility to perform at least one beverage preparation routine based at least in part on the at least one beverage preparation routine performed by the second beverage preparation utility.

2. The beverage station of claim 1, wherein the second beverage preparation utility is configured to perform at least one beverage preparation routine based at least in part on a time elapsed in a beverage preparation routine performed by the first beverage preparation utility.

3. (canceled)

4. (canceled)

5. The beverage station of claim 1, wherein the controller is configured to coordinate a plurality of beverage preparation routines based at least in part on a predetermined preparation timing such that a plurality of beverages is prepared at least partially concurrently.

6. The beverage station of claim 1, further comprising a display communicatively coupled to at least one of the first beverage preparation utility, the second beverage preparation utility or the controller.

7. (canceled)

8. (canceled)

9. (canceled)

10. (canceled)

11. The beverage station of claim 1, wherein at least one of the first beverage preparation utility or the second beverage preparation utility comprises a continuous refill system, wherein the continuous refill system is configured to automatically fill a container placed thereon to a desired point upon indication that the container is not filled to the desired point.

12. The beverage station of claim 11, wherein the continuous refill system is configured to fill the container with at least one of liquid or ice.

13. The beverage station of claim 11, wherein the continuous refill system further comprises at least one of a pressure sensor, a light sensor, or a scale.

14. The beverage station of claim 1, wherein the plurality of beverage preparation utilities further comprises at least one additional beverage preparation utility other than the first beverage preparation utility and the second beverage preparation utility, wherein the at least one additional beverage preparation utility is configured to operate at least in part concurrently with at least one of the first beverage preparation utility or the second beverage preparation utility.

15. The beverage preparation station of claim 1, wherein the plurality of beverage preparation utilities further comprises at least one beverage preparation utility substantially similar to and adjacent the first beverage preparation utility, and at least one beverage preparation utility substantially similar to and adjacent the second beverage preparation utility.

16. The beverage preparation station of claim 15, wherein the first beverage preparation utility and the substantially adjacent beverage preparation utility comprise two adjacent espresso machines, and wherein the second beverage preparation utility and the substantially adjacent beverage preparation utility comprise two adjacent milk systems.

17. The beverage preparation station of claim 14, further comprising two continuous refill systems substantially adjacent each other, wherein each continuous refill system is configured to automatically fill a container placed thereon to a desired point upon indication that the container is not filled to the desired point.

18. The beverage station of claim 1, wherein at least one of the first beverage preparation system or the second beverage preparation system is at least one of an automatic espresso system, a steamed milk system, a cold milk system, a hot water system, an ambient water system, an ice system, or a powder system.

19. A method of preparing a beverage comprising:
causing a first beverage preparation utility to perform a first beverage preparation routine; and
causing a second beverage preparation utility to perform a second beverage preparation routine,
wherein at least a portion of the second beverage preparation routine is based at least in part on timing of at least a portion of the first beverage preparation routine.

20. The method of claim 19, further comprising determining a time to completion of the first beverage preparation routine, wherein causing a second beverage preparation utility to perform a second beverage preparation routine comprises initiating the second beverage preparation routine based at least in part on the determined time to completion of the first beverage preparation routine.

21. The method of claim 19, further comprising causing the first beverage preparation utility and the second beverage preparation utility to perform the first beverage preparation routine and the second beverage preparation routine concurrently.

22. (canceled)

23. The method of claim 19, wherein at least one of the first beverage preparation routine or the second beverage preparation routine comprises pulling an espresso shot.

24. The method of claim 19, wherein at least one of the first beverage preparation routine or the second beverage preparation routine comprises steaming milk.

25. (canceled)

26. The method of claim 19, wherein at least one of the first beverage preparation routine or the second beverage preparation routine comprises receiving an indication that a fill level of a container has fallen below a target fill level; and
causing at least one beverage preparation utility to fill the container with until the target fill level of the container is reached.

27. The method of claim 19, further comprising transmitting data based on at least one of the first beverage preparation routine or the second beverage preparation routine to a machine learning system;
receiving instructions from the machine learning system; and
adjusting at least one of the first beverage preparation routine or the second beverage preparation routine based on the instructions.

28. The method of claim 19, further comprising transmitting instructions to one or more of the first beverage preparation utility and the second beverage preparation utility to cause the one or more of the first beverage preparation utility and the second beverage preparation utility to pre-prepare beverage ingredients.

29-35. (canceled)
